(19) United States
(12) Patent Application Publication
(10) Pub. No.: US 2024/0378898 A1
(43) Pub. Date: Nov. 14, 2024

(54) METHOD AND APPARATUS FOR RECOGNIZING A LANE LINE BASED ON LIDAR

(71) Applicants: HYUNDAI MOTOR COMPANY, Seoul (KR); KIA CORPORATION, Seoul (KR)

(72) Inventor: Woo Cheol Choi, Incheon (KR)

(73) Assignees: HYUNDAI MOTOR COMPANY, Seoul (KR); KIA CORPORATION, Seoul (KR)

(21) Appl. No.: 18/523,283

(22) Filed: Nov. 29, 2023

(30) Foreign Application Priority Data
May 9, 2023 (KR) 10-2023-0059814

(51) Int. Cl. G06V 20/56; G01S 17/89; G06T 7/543

(52) U.S. Cl. CPC G06V 20/588; G01S 17/89; G06T 7/543; G06T 2207/10028

(57) ABSTRACT

A method and an apparatus for recognizing a lane line based on LiDAR are disclosed. The method includes acquiring candidate points of a lane line around an ego vehicle by using a LiDAR sensor, determining at least one straight line by using the candidate points, and determining a curve using final points corresponding to the at least one straight line.

### CROSS-REFERENCE TO RELATED APPLICATION

This application claims the benefit of Korean Patent Application No. 10-2023-0059814, filed on May 9, 2023, which is hereby incorporated by reference as if fully set forth herein.

### TECHNICAL FIELD

The present disclosure relates to a method and an apparatus for recognizing a lane line based on LiDAR.

### BACKGROUND

Conventionally, in order to recognize a lane line using LiDAR, ground points having high reflection intensity are extracted from LiDAR point data. After clustering thereof, the points are approximated to determine a line, thereby recognizing the lane line.

As a clustering method, as illustrated in FIG. 1, a method using a constant Euclidean distance (left diagram) and a method using a window (right diagram) may be used.

However, according to these methods, as illustrated in FIG. 1, there is a problem in that a recognition rate is low in the case of curved lane lines, unlike straight lane lines.

In addition, in the conventional method, a reflection intensity value of a point is essential. However, there is a problem that some LiDAR sensors do not support a reflection intensity value. As an example, Valeo's “Scalar Gen 2” does not support a reflection intensity value of a point.

There may be an echo pulse width (EPW) value in addition to the reflection intensity value. However, accuracy is low and there is a problem in that a lane line point and a non-lane line point cannot be characterized and distinguished only using the EPW value.

Meanwhile, FIG. 2 illustrates a result of extracting lines by applying Hough transformation to an image obtained by an image sensor.

A method of extracting lines by applying Hough transformation to LiDAR points and determining a lane line therefrom may be considered based on a conventional method of extracting a straight line from an image. However, the conventional method requires a large amount of computation for extracting a straight line through Hough transformation. Thus, the conventional method requires a high-performance processor, is not suitable for a real-time property, and has limitations of not recognizing curved lane lines.

In vehicles, LiDAR is generally used to recognize objects on the ground. However, lane line recognition based on LiDAR is required to more accurately determine a driving environment or situation of an ego vehicle.

FIG. 3 illustrates a conventional object recognition result based on LiDAR.

FIG. 3 illustrates LiDAR data for a scene in which an ego vehicle HV is driven in a tunnel, and an emergency stop section sunk into a tunnel wall in front of the ego vehicle HV is output as an object bounding box BB.

Whether the object bounding box BB is invading a driving lane line of the ego vehicle HV cannot be determined based on a recognition result of FIG. 3, and thus there is a limit to accurately determining a driving situation.

In addition, FIG. 4 illustrates a LiDAR recognition result (lower picture) for a night driving situation (upper picture).

For object recognition based on LiDAR, raw data is subject to preprocessing such as noise removal, and at this time, points having low reflection intensities may be treated as noise.

However, during night driving, reflection intensities of points reflected from some lane lines may be relatively high due to lighting. As a result, as illustrated in FIG. 4, some points O1 and O2 reflected from the lane lines may remain without being treated as noise.

In this case, the points may generally be classified as “unknown” objects, which may affect control of the ego vehicle by a driving system.

For these reasons, a novel method and an apparatus for recognizing a lane line based on LiDAR are required.

### SUMMARY

Accordingly, the present disclosure is directed to a method and an apparatus for recognizing a lane line based on LiDAR that substantially obviate one or more problems due to limitations and disadvantages of the related art.

An object of the present disclosure is to solve at least one of the problems of the conventional art described above.

A method and an apparatus of at least one embodiment of the present disclosure is based on LiDAR. Another object of the present disclosure is to recognize a curved lane line without requiring an excessive amount of computation.

Additional advantages, objects, and features, of the disclosure are set forth in part in the following description and in part should become apparent to those having ordinary skill in the art upon examination of the following or may be learned from practice of the present disclosure. The objects and other advantages of the disclosure may be realized and attained by the structures particularly pointed out in the written description and claims thereof as well as the appended drawings.

To achieve these objects and other advantages and in accordance with the purpose of the present disclosure, as embodied and broadly described herein, a method of recognizing a lane line based on LiDAR includes acquiring candidate points of a lane line around an ego vehicle by using a LiDAR sensor. The method also includes determining at least one straight line using the candidate points. The method also includes determining a curve by using final points corresponding to the at least one straight line.

In at least one embodiment of the present disclosure, acquiring the candidate points includes acquiring LiDAR point data for each frame of a plurality of time frames. Acquiring the candidate points also includes acquiring ground points for each frame from the LiDAR point data for each frame. Acquiring the candidate points also includes selecting candidate points for each frame from the ground points for each frame.

In at least one embodiment of the present disclosure, selecting the candidate points includes selecting, as candidate points, ground points located at a first set distance or farther from the ego vehicle in a longitudinal direction among the ground points for each frame.

Alternatively, selecting the candidate points also includes selecting, as candidate points, ground points each having an echo pulse width (EPW) value greater than or equal to a reference value among ground points for each frame. The ground points are located from a second set distance to the first set distance from the ego vehicle in the longitudinal direction among the ground points.

In at least one embodiment of the present disclosure, acquiring the candidate points further includes correcting coordinate values of the candidate points for each frame according to a movement amount of the ego vehicle.

In at least one embodiment of the present disclosure, determining the at least one straight line includes determining a smaller number of secondary candidate points from whole candidate points obtained by combining the candidate points for each frame.

In at least one embodiment of the present disclosure, determining the secondary candidate points includes applying voxel grid filtering to the whole candidate points.

In at least one embodiment of the present disclosure, determining the at least one straight line includes determining a straight line through Hough transformation for the secondary candidate points.

In at least one embodiment of the present disclosure, determining the straight line through Hough transformation includes determining a straight line by applying Hough transformation to the secondary candidate points for each individual search region having a set angular range for a search region having a set range on both left and right sides in front of the ego vehicle.

In at least one embodiment of the present disclosure, determining the straight line by applying Hough transformation to the secondary candidate points for each individual search region includes applying Hough transformation while sweeping a search line by a set angular interval for the individual search region.

In at least one embodiment of the present disclosure, determining the curve includes determining a curve through curve fitting for the final points.

In another aspect of the present disclosure, an apparatus for recognizing a lane line based on LiDAR includes an interface configured to receive LiDAR point data about surroundings of an ego vehicle from a LiDAR sensor. The apparatus also includes a memory configured to store instructions for recognizing the lane line based on LiDAR. The apparatus also includes at least one processor configured to execute the instructions. By executing the instructions, the at least one processor is configured to acquire candidate points of a lane line around the ego vehicle. The at least one processor is also configured to determine at least one straight line by using the candidate points. The at least one processor is also configured to determine a curve by using final points corresponding to the at least one straight line.

In at least one embodied apparatus of the present disclosure, when acquiring the candidate points, the at least one processor is configured to acquire LiDAR point data for each frame of a plurality of time frames. The at least one processor is configured to acquire ground points for each frame from the LiDAR point data for each frame. The at least one processor is configured to select candidate points for each frame from the ground points for each frame.

In at least one embodied apparatus of the present disclosure, when selecting the candidate points, the at least one processor is configured to select, as candidate points, ground points located at a first set distance or farther from the ego vehicle in a longitudinal direction among the ground points for each frame. Alternatively, the at least one processor is configured to select, as candidate points, ground points each having an EPW value greater than or equal to a reference value among ground points for each frame. The ground points are located from a second set distance to the first set distance from the ego vehicle in the longitudinal direction.

In at least one embodied apparatus of the present disclosure, when acquiring the candidate points, the at least one processor is further configured to correct coordinate values of the candidate points for each frame according to a movement amount of the ego vehicle.

In at least one embodied apparatus of the present disclosure, when determining the at least one straight, the at least one processor is configured to determine a smaller number of secondary candidate points from whole candidate points obtained by combining the candidate points for each frame.

In at least one embodied apparatus of the present disclosure, when determining the secondary candidate points, the at least one processor is configured to apply voxel grid filtering to the whole candidate points.

In at least one embodied apparatus of the present disclosure, when determining the at least one straight line, the at least one processor is configured to determine a straight line through Hough transformation for the secondary candidate points.

In at least one embodied apparatus of the present disclosure, when determining the straight line through Hough transformation, the at least one processor is configured to determine a straight line by applying Hough transformation to the secondary candidate points for each individual search region having a set angular range for a search region having a set range on both left and right sides in front of the ego vehicle.

In at least one embodied apparatus of the present disclosure, when determining the straight line by applying Hough transformation to secondary candidate points for each individual search region, the at least one processor is configured to apply Hough transformation while sweeping a search line by a set angular interval for the individual search region.

In at least one embodied apparatus of the present disclosure, determining the curve, the at least one processor is configured to determine a curve through curve fitting for the final points.

It should be understood that both the foregoing general description and the following detailed description of the present disclosure are exemplary and explanatory and are intended to provide further explanation of the present disclosure.

### BRIEF DESCRIPTION OF THE DRAWINGS

The accompanying drawings are included to provide a further understanding of the present disclosure and are incorporated in and constitute a part of the present disclosure. The accompanying drawings illustrate embodiment(s) of the present disclosure and together with the description and serve to explain the principle of the present disclosure. In the drawings:

FIG. 1 illustrates a conventional method of recognizing a lane line based on LiDAR;

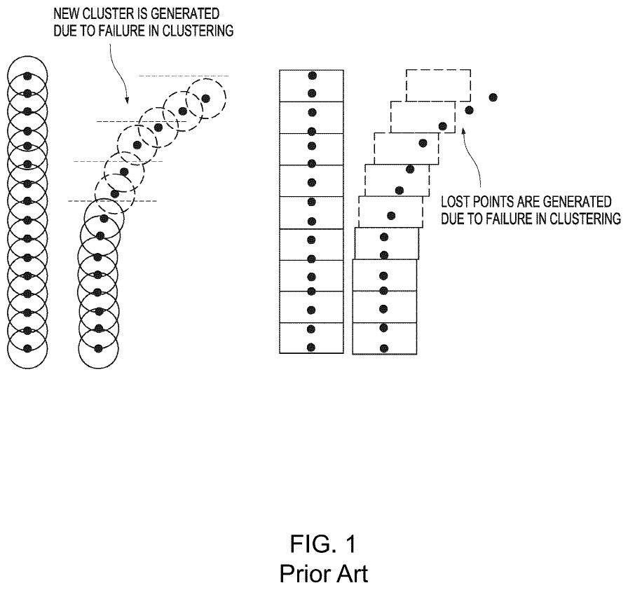

FIG. 2 illustrates a result of extracting a straight line using an image sensor;

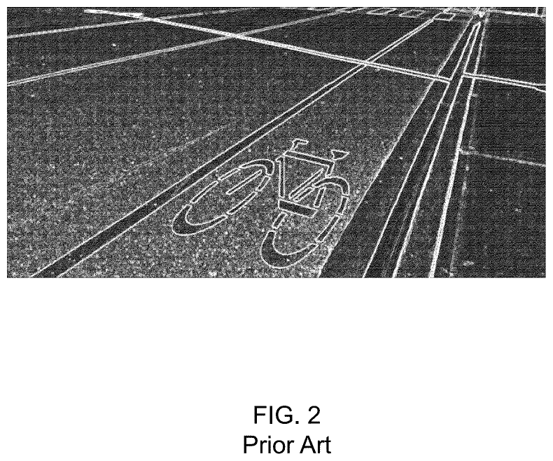

FIG. 3 illustrates an object recognition result based on LiDAR according to a conventional method for a driving situation in a tunnel;

FIG. 4 illustrates an object recognition result based on LiDAR according to a conventional method for a night driving situation;

FIG. 5 is a conceptual diagram illustrating an apparatus for recognizing a lane line based on LiDAR according to an embodiment of the present disclosure;

FIG. 6 is a flowchart illustrating a method of recognizing a lane line based on LiDAR according to an embodiment of the present disclosure;

FIG. 7 illustrates candidate points for each frame for a plurality of time frames;

FIG. 8 conceptually illustrates an example of applying voxel grid filtering to candidate points;

FIG. 9 conceptually illustrates a process of applying Hough transformation to individual search regions;

FIG. 10 conceptually illustrates search lines for applying Hough transformation in individual search regions;

FIG. 11 illustrates straight lines determined by applying Hough transformation to all candidate points of FIG. 7;

FIG. 12 conceptually illustrates a process of applying curve fitting to final points;

FIG. 13 illustrates a result of applying lane line recognition according to an embodiment of the present disclosure to the situation of FIG. 3; and

FIG. 14 illustrates a result of applying lane line recognition according to an embodiment of the present disclosure to the situation of FIG. 4.

### DETAILED DESCRIPTION

The present disclosure may be variously changed and may have various embodiments, though specific embodiments are illustrated and described in the drawings. However, this is not intended to limit the present disclosure to a specific embodiment and it should be understood to include all changes, equivalents, or substitutes included in the spirit and technical scope of the present disclosure.

The terms “module” and “unit” used in the present disclosure are only used for denominative distinction between elements. The terms should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. The terms may be used only as denominative meanings to distinguish one element from another. The sequential meanings of the terms are determined not by names but by the context of the corresponding description.

The term “and/or” is used to include any combination of a plurality of items that are the subject matter. For example, “A and/or B” inclusively means all three cases, such as “A”, “B”, and “A and B”.

When an element is referred to as being “coupled” or “connected” to another element, the element may be directly coupled or connected to the other element. However, it should be understood that another element may be present therebetween.

Terms used in the present disclosure are only used to describe specific embodiments and are not intended to limit the present disclosure. A singular expression includes the plural form unless the context clearly dictates otherwise. In the present disclosure, it should be understood that terms such as “include” or “have” and variations thereof are intended to designate a presence of the features, numbers, steps, operations, elements, parts, or combinations thereof described in the present disclosure. The terms do not preclude the possibility of the addition or presence of one or more other features, numbers, steps, operations, elements, parts, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art. Unless explicitly defined in this application, the terms should not be interpreted as having ideal or excessively formal meanings.

In addition, the terms “unit” or “control unit” are merely widely used terms for a controller that controls a specific function, and the terms do not mean a generic functional unit. For example, each unit or control unit may include a communication device for communicating with another controller or a sensor to control a function assigned thereto. Each unit or control unit may also include a computer-readable recording medium that stores an operating system, a logic command, input/output information, etc. Each unit or control unit may also include one or more processors that perform determination, calculation, decision, etc. necessary for controlling a function assigned thereto. When a component, device, unit, element, or the like of the present disclosure is described as having a purpose or performing an operation, function, or the like, the component, device, unit, element, or the like should be considered herein as being “configured to” meet that purpose or to perform that operation or function. Each component, device, unit, element, and the like may separately embody or be included with a processor and a memory, such as a non-transitory computer readable media, as part of the apparatus.

Meanwhile, a processor may include a semiconductor integrated circuit and/or electronic devices that perform at least one of comparison, determination, calculation, and decision to achieve programmed functions. In an embodiment, the processor may be any one or a combination of a computer, a microprocessor, a CPU, an ASIC, and an electronic circuit (circuitry or logic circuit).

In addition, a computer-readable recording medium (or simply a memory) includes all types of storage devices in which data readable by a computer system is stored. In an embodiment, it is possible to include at least one of memories of flash memory type, hard disk type, micro type, card type (for example, secure digital card (SD card) or eXtreme Digital Card (XD card)), etc., a random access memory (RAM), a static RAM (SRAM), a read-only memory (ROM), a programmable ROM (PROM), an electrically erasable PROM (EEPROM), a magnetic memory (MRAM), or memories of magnetic disk and optical disc types.

This recording medium may be electrically connected to the processor, and the processor may read and record data from the recording medium. The recording medium and the processor may be integrated with each other or may be physically separated from each other.

Hereinafter, the accompanying drawings are briefly described, and embodiments of the present disclosure are described in detail with reference to the drawings.

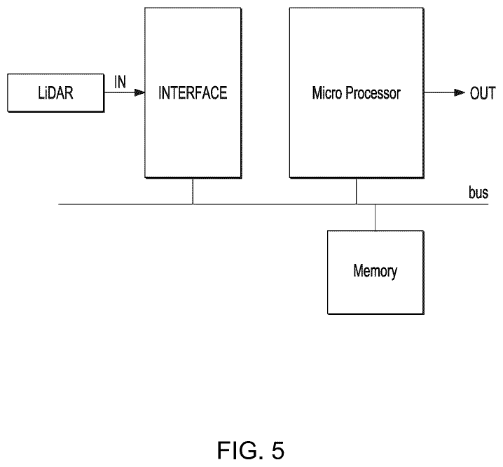

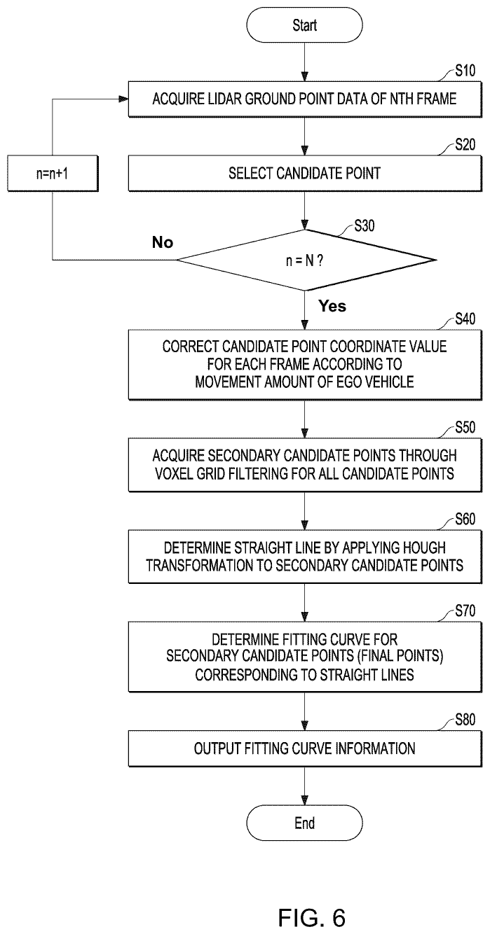

FIG. 5 is a conceptual diagram illustrating an apparatus for recognizing a lane line based on LiDAR according to an embodiment of the present disclosure. FIG. 6 is a flowchart illustrating a method of recognizing a lane line based on LiDAR according to an embodiment of the present disclosure.

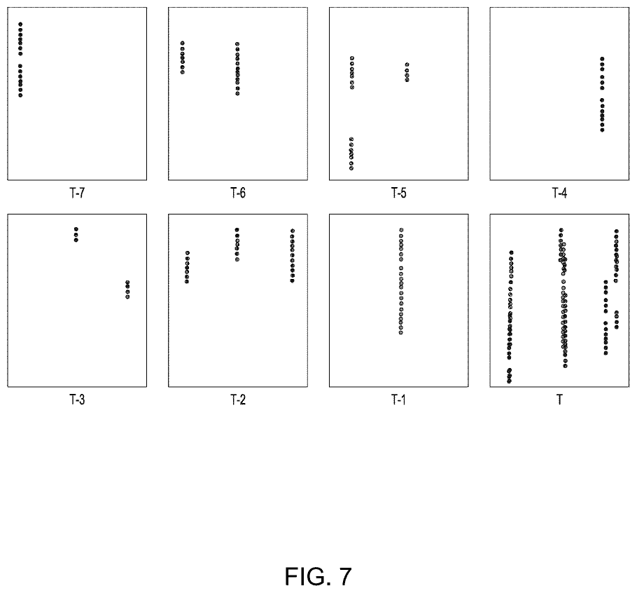

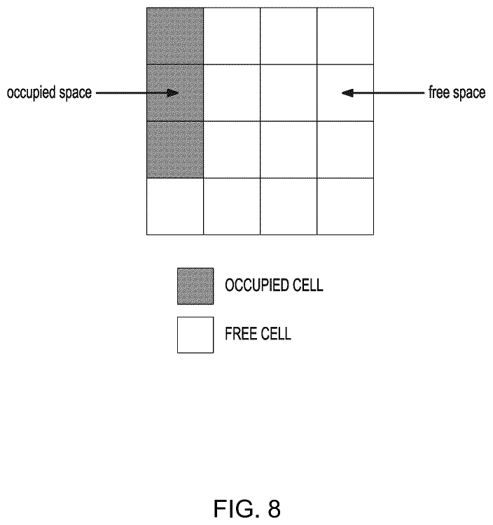

FIG. 7 illustrates candidate points for each frame for a plurality of time frames. FIG. 8 conceptually illustrates an example of applying voxel grid filtering to candidate points.

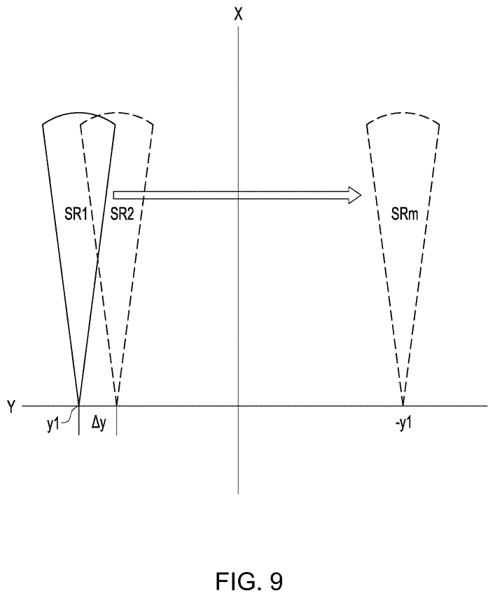

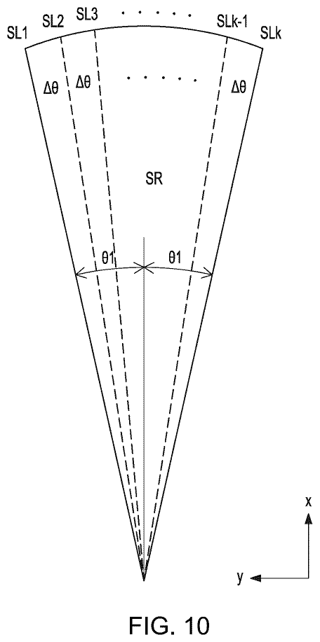

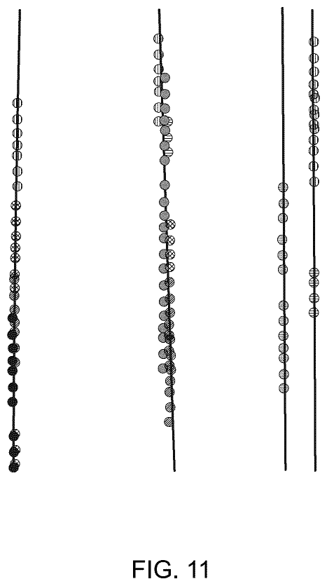

FIG. 9 conceptually illustrates a process of applying Hough transformation to individual search regions. FIG. 10 conceptually illustrates search lines for applying Hough transformation in individual search regions. FIG. 11 illustrates straight lines determined by applying Hough transformation to all candidate points of FIG. 7.

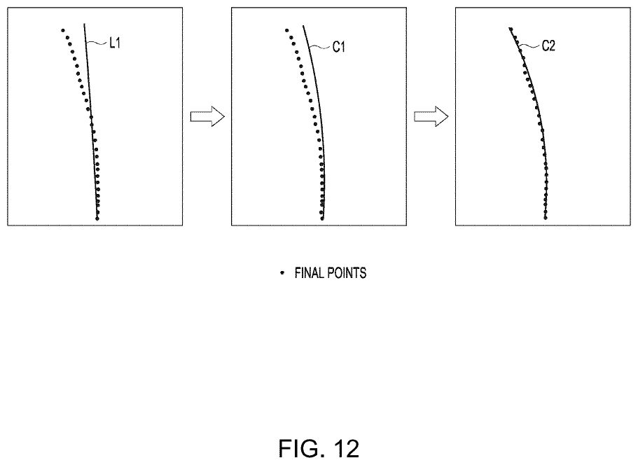

Further, FIG. 12 conceptually illustrates a process of applying curve fitting to final points.

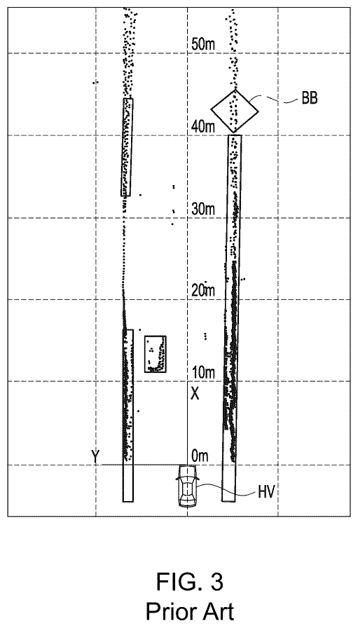

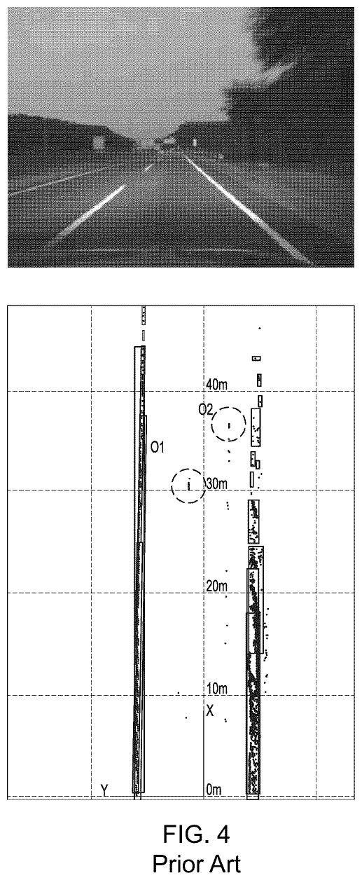

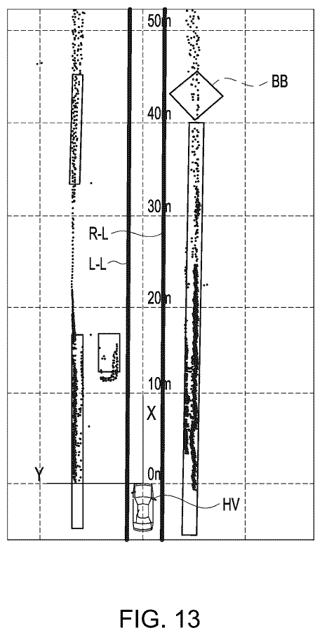

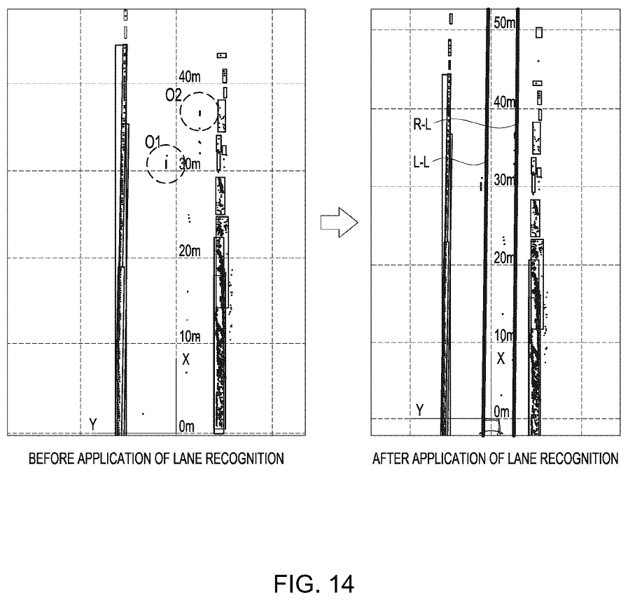

In addition, FIG. 13 illustrates a result of applying lane line recognition according to an embodiment of the present disclosure to the situation of FIG. 3. FIG. 14 illustrates a result of applying lane line recognition according to an embodiment of the present disclosure to the situation of FIG. 4.

Referring to FIG. 5, an apparatus for recognizing an object based on LiDAR includes an interface, a processor, and a memory.

The apparatus for recognizing the object based on LiDAR may be mounted as an electronic component in a vehicle.

The apparatus for recognizing the object based on LiDAR may be provided as an independent electronic component or may be integrated with another electronic component in the vehicle.

In an embodiment, the apparatus may be integrated with another advanced driving assistance system (ADAS) functional device or a vehicle control device.

The interface may be hardware that electrically connects a LiDAR sensor with the processor and/or the memory and transfers data received from the LiDAR sensor to the processor and/or the memory.

The memory stores instructions (for example, a computer program) for performing a method of recognizing a lane line described below and/or data necessary therefor (for example, preset values required for performing the above-described method of recognizing the lane line).

The processor calls the instructions from the memory, executes the instructions, and performs lane line recognition based on LiDAR according to execution.

In the present embodiment, the LiDAR sensor may be a solid state LiDAR. However, the present disclosure is not limited thereto.

Hereinafter, a lane line recognition process according to an embodiment of the present disclosure is described in detail through the flowchart illustrated in FIG. 6.

First, in step S10, LiDAR ground point data for each time frame is acquired through the LiDAR sensor.

To this end, raw data acquired by the LiDAR sensor may undergo a preprocessing process.

The preprocessing process may include a calibration process of matching coordinates between the LiDAR sensor and the vehicle equipped with the LiDAR sensor. In other words, LiDAR data may undergo a coordinate transformation process in accordance with a reference coordinate system according to a position angle of the LiDAR sensor mounted on the vehicle.

Further, in the preprocessing process, noise may be removed through intensity or confidence information of the LiDAR data.

Further, in the preprocessing process, data included by being reflected on a body of the ego vehicle may be removed.

Points corresponding to the ground may be extracted from point data undergoing the preprocessing process, and candidate points for the lane line are selected from among ground points in step S20.

To this end, among ground points located at a first set distance or more from the ego vehicle in a longitudinal direction (x-axis direction in the accompanying drawings) and/or ground points from a second set distance to the first set distance, points having echo pulse width (EPW) values greater than or equal to a reference value may be selected as the candidate points.

For example, the first set distance may be 30 m and the second set distance may be 20 m.

Points reflected from the ground more than 30 m away are mostly lost or removed as noise. However, since lane lines are painted with bright colors, reflection points thereof may be acquired from far away. Therefore, ground points located at a distance of 30 m or more are highly likely to be candidate points of the lane line.

With regard to ground points in a range of 20 to 30 m, in particular, points having EPW values greater than or equal to the reference value are selected as candidate points in order to reduce an effect of lighting at night.

Meanwhile, for object recognition after the above-described preprocessing of raw data, a clustering process, an object detection process, etc. may be performed on points other than the ground points.

In the clustering process, LiDAR points are grouped into a plurality of clusters by a clustering algorithm.

In addition, for each cluster, a square-shaped cluster box including corresponding points may be defined.

These clusters become object candidates to be detected, and a shape of the object is analyzed through the object detection process.

For example, representative points may be extracted from points included in a cluster, and an outer point may be determined from among the representative points using a “convex hull” algorithm.

Further, among rectangular boxes surrounding the outer points, a rectangular box in which the sum of distances from the outer points to a shortest side is the smallest, i.e., a so-called bounding box, may be defined.

In short, shape information (for example, an outer point, a bounding box, etc.) for each object is acquired through the above-described process for LiDAR data.

Because object detection from LiDAR data has previously been known, further detailed description has been omitted.

Among objects around the ego vehicle, in the case of other vehicles, there are cases where wheels cannot be separated from the ground. In other words, there may be cases where a lower part of an object is treated as ground points.

Such points increase lane line detection time and may become an obstacle to determining a straight line based on Hough transformation performed below.

Therefore, these points need to be removed.

To this end, in step S20, ground points overlapping a bounding box of any one object are excluded from the candidate points.

Steps S10 and S20 may be repeatedly performed for a set number of time frames (S30), and in this way, it is possible to ensure candidate points for each frame for a set number of frames.

Next, in step S40, coordinate values of the candidate points for each frame are corrected by the movement amount of the ego vehicle according to a time point of a current frame.

FIG. 7 illustratively shows candidate points of 8 time frames and shows an example in which all points of each time frame are integrated into a current time frame (T).

When whole candidate points obtained by combining candidate points of a plurality of frames are used without change, the amount of computation and calculation time may be great due to the large amount of data, and thus the amount of data needs to be reduced.

To this end, in step S50, voxel grid filtering is applied to the whole candidate points, and in this way, secondary candidate points are obtained.

FIG. 8 conceptually illustrates a voxel grid filtering process through a plan view, and the voxel grid filtering process is described using the figure.

The whole candidate points may be mapped to a voxel grid map including voxels having a set size and shape, and the number of candidate points occupying each voxel may be determined.

Then, it is possible to distinguish a voxel including at least one point (hereinafter referred to as “occupied cell”) and a voxel including no point (hereinafter referred to as “free cell”) therefrom.

In this instance, for each voxel, “1” may be designated as a flag in the case of an occupied cell, and “0” may be designated in the case of a free cell.

Further, in the case of an occupied cell, information on the number of occupied points may be stored in addition to flag information.

When the occupied cells are determined, representative points (for example, center points of the corresponding voxels) of the occupied cells may be determined.

Through this process, a flag value, a representative point coordinate value, and the number of occupied candidate points may be determined for each voxel.

Representative points of the occupied cells are determined as secondary candidate points and are used for straight line detection through application of Hough transformation in step S60. It is apparent that, when the number of all candidate points in a plurality of frames is not large, i.e., when the number is less than or equal to the set number, step S50 may be omitted, and all candidate points may be determined as secondary candidate points.

When voxel grid filtering is applied, the number of candidate points stored in an occupied cell may be used as a weight when a straight line is detected by Hough transformation.

For example, when a plurality of straight lines is detected for certain points, a straight line having the largest size may be determined as a straight line of the points by summing weights of points corresponding to each straight line.

Hereinafter, a process of applying Hough transformation is described with reference to FIGS. 9 and 10.

As shown in FIG. 9, Hough transformation is applied to each search region by setting a set range (a range from −y to y in a horizontal direction, i.e., in a y-axis direction) to an entire search region.

In other words, Hough transformation is applied to the corresponding points in a first search region, then applied to a second search region separated by a set distance in the y-axis direction, and then applied to a final m^{th} search region.

Each search region may be determined to have a set angular range θ1 on both sides based on a longitudinal direction, i.e., an x-axis direction.

In addition, as shown in FIG. 10, application of Hough transformation to individual search regions (SR) may be performed while sweeping search lines SL1, SL2, . . . , SLk at each set angular interval Δθ.

Because a slope of a straight line connecting the LiDAR points of the lane line may be within a set angular range based on the ego vehicle, computation efficiency may be increased by limiting an individual search region to the set angular range θ1 as described above.

FIG. 11 illustrates a result of determining straight lines through the above process for all candidate points of FIG. 7.

After straight lines for the secondary candidate points are determined, in step S70, a curve is determined by applying curve fitting to points corresponding to the straight lines, i.e., final points.

FIG. 12 conceptually illustrates a curve determination process, and in this way, a curve fitting process is described.

Referring to FIG. 12, a primary curve C1 is obtained by first performing curve fitting based on a polynomial curve on final points corresponding to a straight line L1 determined by Hough transformation. A secondary curve C2 may be obtained by increasing the polynomial order when the primary curve has a large deviation from the points.

Further, a final curve thus obtained may be determined as the lane line, and related information including a curve equation thereof may be output (S80).

FIG. 13 illustrates a result of applying lane line recognition according to an embodiment of the present disclosure to the situation of FIG. 3.

As shown in FIG. 13, as a left lane line L-L and a right lane line R-L of a driving lane of the ego vehicle HV are recognized, whether the object bounding box BB invades the driving lane of the ego vehicle HV may be determined. In addition, accurate determination of the driving situation becomes possible based on such determination.

Meanwhile, FIG. 14 illustrates a result (right drawing) of applying lane line recognition according to an embodiment of the present disclosure to the situation of FIG. 4.

As shown in FIG. 14, it can be confirmed that objects classified as “unknown” objects O1 and O2 actually correspond to lane line data by applying lane line recognition.

A method and an apparatus of at least one embodiment of the present disclosure may recognize a curved lane line based on LiDAR.

In addition, a method and an apparatus of at least one embodiment of the present disclosure do not require an excessive amount of computation. Thus, the method and the apparatus do not require a high-performance processor and are suitable for real-time.

It should be apparent to those having ordinary skill in the art that various modifications and variations can be made in the present disclosure without departing from the spirit or scope of the disclosure. Thus, it is intended that the present disclosure cover the modifications and variations of the present disclosure when the modifications and variations fall within the scope of the appended claims and their equivalents.

What is claimed is:

1. A method of recognizing a lane line based on LiDAR, the method comprising:
acquiring candidate points of a lane line around an ego vehicle by using a LiDAR sensor;
determining at least one straight line using the candidate points; and
determining a curve by using final points corresponding to the at least one straight line.

2. The method of claim 1, wherein acquiring the candidate points comprises
acquiring LiDAR point data for each frame of a plurality of time frames,
acquiring ground points for each frame from the LiDAR point data for each frame, and
selecting candidate points for each frame from the ground points for each frame.

3. The method of claim 2, wherein selecting the candidate points comprises:
selecting, as candidate points, ground points located at a first set distance or farther from the ego vehicle in a longitudinal direction among the ground points for each frame; or
selecting, as candidate points, ground points each having an echo pulse width (EPW) value greater than or equal to a reference value among ground points from each frame, the ground points located from a second set distance to the first set distance from the ego vehicle in the longitudinal direction.

4. The method of claim 2, wherein acquiring the candidate points further comprises correcting coordinate values of the candidate points for each frame according to a movement amount of the ego vehicle.

5. The method of claim 2, wherein determining the at least one straight line comprises determining a smaller number of secondary candidate points from whole candidate points obtained by combining the candidate points for each frame.

6. The method of claim 5, wherein determining the secondary candidate points comprises applying voxel grid filtering to the whole candidate points.

7. The method of claim 5, wherein determining the at least one straight line comprises determining a straight line through Hough transformation for the secondary candidate points.

8. The method of claim 7, wherein determining the straight line through Hough transformation comprises determining a straight line by applying Hough transformation to the secondary candidate points for each individual search region having a set angular range for a search region having a set range on both left and right sides in front of the ego vehicle.

9. The method of claim 8, wherein determining the straight line by applying Hough transformation to the secondary candidate points for each individual search region comprises applying Hough transformation while sweeping a search line by a set angular interval for the individual search region.

10. The method of claim 1, wherein determining the curve comprises determining a curve through curve fitting for the final points.

11. An apparatus for recognizing a lane line based on LiDAR, the apparatus comprising:
an interface configured to receive LiDAR point data about surroundings of an ego vehicle from a LiDAR sensor;
a memory configured to store instructions for recognizing the lane line based on LiDAR; and
at least one processor configured to execute the instructions,
wherein, by executing the instructions, the at least one processor is configured to
acquire candidate points of a lane line around the ego vehicle,
determine at least one straight line by using the candidate points, and
determine a curve by using final points corresponding to the at least one straight line.

12. The apparatus according to claim 11, wherein, when acquiring the candidate points, the at least one processor is configured to:
acquire LiDAR point data for each frame of a plurality of time frames;
acquire ground points for each frame from the LiDAR point data for each frame; and
select candidate points for each frame from the ground points for each frame.

13. The apparatus according to claim 12, wherein, when selecting the candidate points, the at least one processor is configured to:
select, as candidate points, ground points located at a first set distance or farther from the ego vehicle in a longitudinal direction among the ground points for each frame; and/or
select, as candidate points, ground points each having an EPW value greater than or equal to a reference value among ground points for each frame, the ground points located from a second set distance to the first set distance from the ego vehicle in the longitudinal direction among the ground points.

14. The apparatus according to claim 12, wherein, when acquiring the candidate points, the at least one processor is further configured to correct coordinate values of the candidate points for each frame according to a movement amount of the ego vehicle.

15. The apparatus according to claim 12, wherein, when determining the at least one straight line, the at least one processor is configured to determine a smaller number of secondary candidate points from whole candidate points obtained by combining the candidate points for each frame.

16. The apparatus according to claim 15, wherein, when determining the secondary candidate points, the at least one processor is configured to apply voxel grid filtering to the whole candidate points.

17. The apparatus according to claim 15, wherein, when determining the at least one straight line, the at least one processor is configured to determine a straight line through Hough transformation for the secondary candidate points.

18. The apparatus according to claim 17, wherein, when determining the straight line through Hough, the at least one processor is configured to determine a straight line by applying Hough transformation to the secondary candidate points for each individual search region having a set angular range for a search region having a set range on both left and right sides in front of the ego vehicle.

19. The apparatus according to claim 18, wherein, when determining the straight line by applying Hough transformation to secondary candidate points for each individual search region, the at least one processor is configured to apply Hough transformation while sweeping a search line by a set angular interval for the individual search region.

20. The apparatus according to claim 11, wherein, when determining the curve, the at least one processor is configured to determine a curve through curve fitting for the final points.
